(19) United States
(12) Patent Application Publication
(10) Pub. No.: US 2011/0094760 A1
(43) Pub. Date: Apr. 28, 2011

(54) SET TYPE FIRE-FIGHTING SPRINKLER INSTALLING DEVICE

(76) Inventor: Young Soon Im, Bucheon-si (KR)

(21) Appl. No.: 12/516,757

(22) PCT Filed: Aug. 27, 2008
(86) PCT No.: PCT/KR08/05004

§ 371 Date: May 28, 2009

(30) Foreign Application Priority Data
Dec. 24, 2007 (KR) 20-2007-0020608
Dec. 24, 2007 (KR) 20-2007-0020609
Aug. 11, 2008 (KR) 10-2008-0078384

(51) Int. Cl. A62C 99/00

(52) U.S. Cl. 169/51

(57) ABSTRACT

Disclosed is a set type fire-fighting sprinkler installing device, which installs a fire-fighting sprinkler through frames connectively installed on a ceiling lengthwise and crosswise, and includes a supporter (100) having a designated length to traverse frames (10) installed at right and left sides thereof; supporter clamps (200) respectively connected to both ends of the supporter (100) to adjust the interval therebetween and fixed to the upper ends of the frames (10); and a sprinkler clamp (300) connected to the middle portion of the supporter (100) to connect a sprinkler (20) in front thereof while fixing the supporter (100) under the condition that the right and left end positions of the supporter (100) are adjusted. Thereby, the device simply variably installs the sprinkler (20) according to the interval between the frames (10) and the position of the sprinkler (20).

### TECHNICAL FIELD

The present invention relates to a device for installing a fire-fighting sprinkler on the ceiling of a construction, and more particularly to a set type fire-fighting sprinkler installing device, which simply and variably fixes a sprinkler to a ceiling according to positions of frames installed on the ceiling or the sprinkler when the sprinkler is installed.

### BACKGROUND ART

In general, sprinklers are apparatuses, which sprinkle water to put out a fire, and it is well known that the sprinklers are installed at the same intervals using frames and supporters buried under a ceiling.

However, since the frames, the supporters, and the sprinklers are separately installed, when position errors or interval errors thereof are generated, it is difficult or impossible to install other facilities.

Particularly, the supporter is installed together with supporter clamps to fix the supporter to the frames and a sprinkler clamp to fix the sprinkler. These respective parts are separately provided and are installed through field assembly, and thus cause various conveniences. That is, since the respective parts are assembled directly on the field and then the assembly is installed, operation efficiency is lowered. Further, since the positions of the parts cannot be varied back and forth under the condition that the respective parts are assembled, the installation of the sprinkler needs to be redesigned according to the positions of the frames or the sprinkler.

### DISCLOSURE

### Technical Problem

Therefore, the present invention has been made in view of the above problems, and it is an object of the present invention to provide a fire-fighting sprinkler installing device, which solves inconvenience of directly assembling a supporter, supporter clamps, and a sprinkler clamp, which are separately provided, on the field, and difficulty in assembling the supporter, the supporter clamps, and the sprinkler clamp due to the frequent generation of errors between the respective parts for installing the sprinkler.

It is another object of the present invention to provide a fire-fighting sprinkler installing device, which solves inconvenience and difficulty in variably installing a sprinkler according to the interval between frames installed on a ceiling and the position of the sprinkler due to uniform sizes and standards of respective parts for installing the sprinkler.

### Technical Solution

In accordance with an aspect of the present invention, the above and other objects can be accomplished by the provision of a set type fire-fighting sprinkler installing device, which installs a fire-fighting sprinkler through frames connectively installed on a ceiling lengthwise and crosswise, comprising a supporter having a designated length to traverse the frames installed at right and left sides thereof; supporter clamps respectively connected to both ends of the supporter to adjust the interval therebetween and fixed to the upper ends of the frames; and a sprinkler clamp connected to the middle portion of the supporter to connect a sprinkler in front thereof while fixing the supporter under the condition that the right and left end positions of the supporter are adjusted.

Each of the supporter clamps may include an upper horizontal surface and right and left vertical surfaces bent from the horizontal surface; connection holes, into which the supporter is inserted, respectively formed through the upper portions of the right and left vertical surfaces; contact plates, which are bent to press and fix the frames, respectively formed at the lower ends of the right and left vertical surfaces; a first bolt penetrating the center of the horizontal surface and tightened to fix the upper end of the supporter inserted into the connection holes; and a second bolt penetrating the right and left vertical surfaces above the contact plates to press the frame inserted between the contact plates.

Support pieces to support the lower portion of the inserted supporter may be respectively bent from the front ends of the lower portions of the right and left connection holes; and an internal maintenance piece, which is cut from one of the right and left vertical surfaces and is bent to the other one of the right and left vertical surfaces, may be formed between the right and left vertical surfaces.

The sprinkler clamp may have a case shape, in which right and left surfaces are opened such that the supporter can be inserted into the opened right and left surfaces, and upper and lower surfaces are widely extended forward and backward, and include connection holes, into which the sprinkler is vertically inserted, formed through the middle portions of the upper and lower surfaces; and a third bolt penetrating at least one surface of the front and rear surfaces of the sprinkler clamp connecting the upper and lower surfaces and tightened to fix the supporter and the sprinkler under the condition that the supporter and the sprinkler contact each other.

Further, the upper and lower surfaces of the sprinkler clamp may be cut such that portions of the upper and lower surfaces of the sprinkler clamp at the right or left side of the connection holes are opened.

The sprinkler clamp may include front and rear vertical surfaces bent at the rear end of the sprinkler clamp such that the supporter can be inserted therebetween; upper and lower support pieces bent inwardly by punching to support the lower portion of the supporter and fix the upper portion of the supporter; and a fourth bolt penetrating the front and rear vertical surfaces below the lower support pieces and tightened to fix the supporter inserted between the upper and lower support pieces.

The sprinkler clamp may be configured such that the front portions of the connection holes are opened under the condition that the front surface of the sprinkler clamp is cut, and include a door pivotally connected to one side of the connection holes to be opened and closed under the condition that the door covers the cut front surface and the upper and lower surfaces of the sprinkler clamp partially including the front portions of the connection holes; a bracket inserted between the upper and lower surfaces of the sprinkler clamp, provided with a coupling hole formed through the front surface thereof to couple with the third bolt, and pivotally connected to the other side of the connection holes to be rotated horizontally; and an opened long hole formed at the tip of the door contacting the bracket at the same height as that of the coupling hole such that the third bolt can be pushed into the long hole.

The sprinkler clamp may have a case shape, in which right and left surfaces are opened such that the supporter can be inserted into the opened right and left surfaces, and upper and lower surfaces are widely extended forward and backward, and include connection holes, into which the sprinkler is vertically inserted, respectively formed through the middle portions of the upper and lower surfaces of the sprinkler clamp; an operation groove formed through a rear portion of the sprinkler clamp, to which the supporter is connected, at a position where the rear surface and the upper surface contact; shaft pieces respectively bent forward at right and left sides of the rear surface of the sprinkler clamp; and an elastic clip penetrating the shaft pieces, including a middle portion, which is protruded through the operation groove under the condition that both ends of the elastic clip are connected to the shaft pieces, and pushing the supporter through the vertical rotation of the elastic clip to fix the supporter in a contact state with the sprinkler.

### ADVANTAGEOUS EFFECTS

In the set type fire-fighting sprinkler installing device of the present invention, since the supporter, the supporter clamps connected to both ends of the supporter, and the sprinkler clamp connected to the middle of the supporter are integrated into one set, and thus a sprinkler is more simply and conveniently installed using the device.

Further, the set type fire-fighting sprinkler installing device of the present invention easily variably installs the sprinkler according to the interval between frames installed on a ceiling and the position of the sprinkler, thus highly enhancing convenience in sprinkler installation.

### DESCRIPTION OF DRAWINGS

The above and other objects, features and other advantages of the present invention will be more clearly understood from the following detailed description taken in conjunction with the accompanying drawings, in which:

FIG. 1 is a perspective view illustrating a set type fire-fighting sprinkler installing device in accordance with the present invention;

FIG. 2 is a perspective view illustrating supporter clamps of the set type fire-fighting sprinkler installing device in accordance with the present invention;

FIG. 3 is an exploded perspective view illustrating a supporter clamp of FIG. 2;

FIG. 4 is a perspective view illustrating a principal portion of a set type fire-fighting sprinkler installing device in accordance with one embodiment of the present invention;

FIG. 5 is an exploded perspective view illustrating a sprinkler clamp of FIG. 4;

FIG. 6 is a perspective view illustrating a principal portion of a set type fire-fighting sprinkler installing device in accordance with a further embodiment of the present invention;

FIG. 7 is an exploded perspective view illustrating a sprinkler clamp of FIG. 6;

FIG. 8 is a side view of FIG. 6;

FIG. 9 is a perspective view illustrating a principal portion of a set type fire-fighting sprinkler installing device in accordance with another embodiment of the present invention;

FIG. 10 is an exploded perspective view illustrating a sprinkler clamp of FIG. 9;

FIG. 11 is a perspective view illustrating a principal portion of a set type fire-fighting sprinkler installing device in accordance with yet another embodiment of the present invention; and

FIG. 12 is a side view illustrating a sprinkler clamp of FIG. 9 in an operating state.

### BEST MODE

Now, preferred embodiments of the present invention will be described in detail with reference to the annexed drawings.

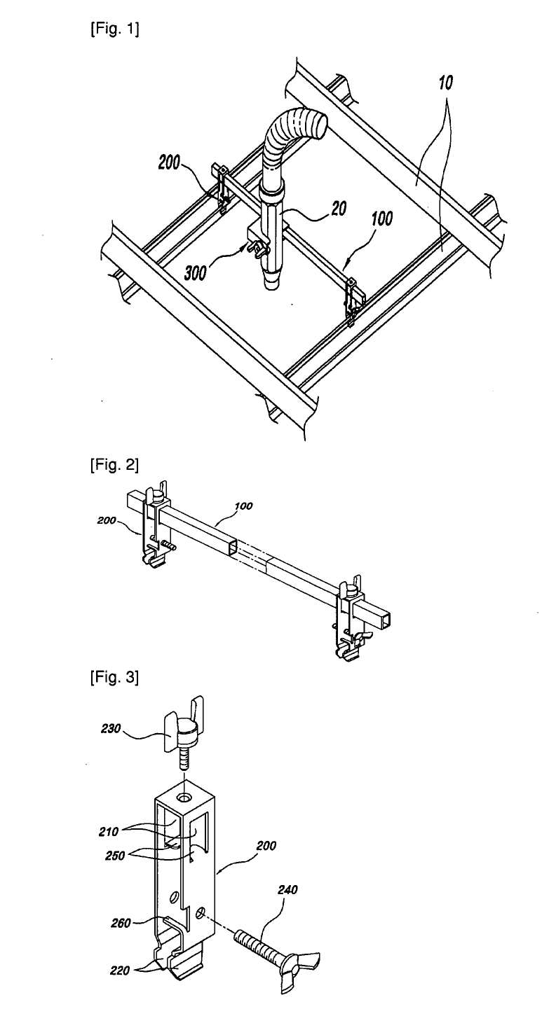

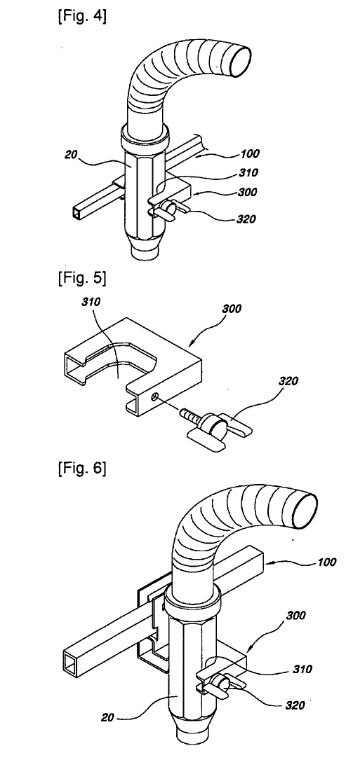

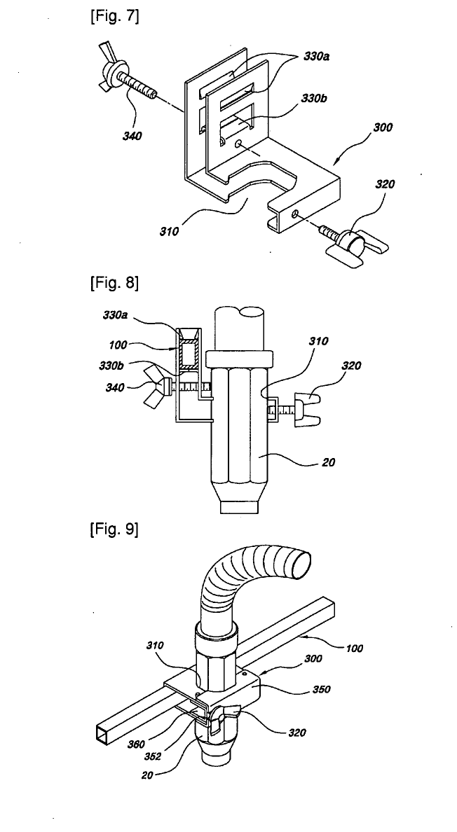

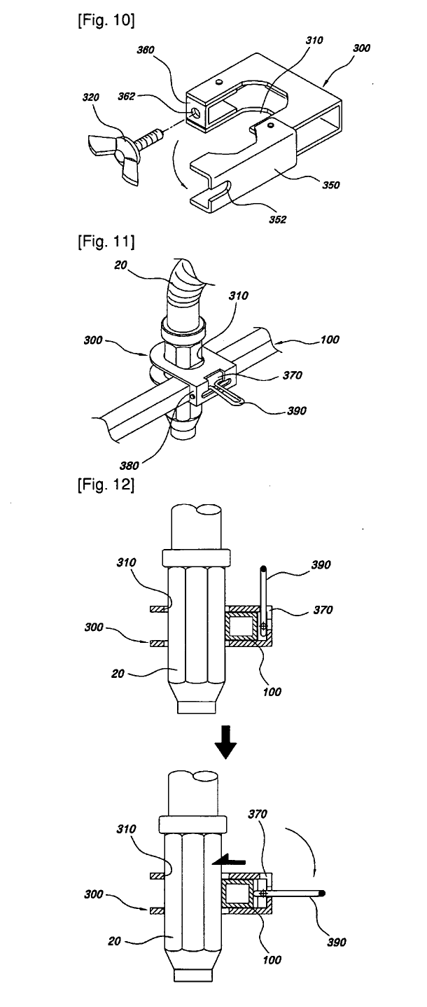

FIG. 1 is a perspective view illustrating a set type fire-fighting sprinkler installing device in accordance with the present invention, FIG. 2 is a perspective view illustrating supporter clamps of the set type fire-fighting sprinkler installing device in accordance with the present invention, FIG. 3 is an exploded perspective view illustrating a supporter clamp of FIG. 2, FIG. 4 is a perspective view illustrating a principal portion of a set type fire-fighting sprinkler installing device in accordance with one embodiment of the present invention, FIG. 5 is an exploded perspective view illustrating a sprinkler clamp of FIG. 4, FIG. 6 is a perspective view illustrating a principal portion of a set type fire-fighting sprinkler installing device in accordance with a further embodiment of the present invention, FIG. 7 is an exploded perspective view illustrating a sprinkler clamp of FIG. 6, FIG. 8 is a side view of FIG. 6, FIG. 9 is a perspective view illustrating a principal portion of a set type fire-fighting sprinkler installing device in accordance with another embodiment of the present invention, FIG. 10 is an exploded perspective view illustrating a sprinkler clamp of FIG. 9, FIG. 11 is a perspective view illustrating a principal portion of a set type fire-fighting sprinkler installing device in accordance with yet another embodiment of the present invention, and FIG. 12 is a side view illustrating a sprinkler clamp of FIG. 9 in an operating state.

As shown in FIGS. 1 to 12, a set type fire-fighting sprinkler installing device in accordance with the present invention includes a supporter 100 having a designated length to traverse frames 10 installed at both sides thereof, i.e., the right and left sides of the supporter 100, supporter clamps 200 respectively connected to both ends of the supporter 100 to adjust the interval therebetween and fixed to the upper ends of the frames 10, and a sprinkler clamp 300 connected to the middle portion of the supporter 100 to connect a sprinkler 20 in front thereof while fixing the supporter 100 under the condition that the right and left end positions of the supporter 100 are adjusted. Thus, the set type fire-fighting sprinkler installing device of the present invention is configured such that the positions of the supporter clamps 200 connected to both ends of the supporter 100 and the position of the sprinkler clamp 300 connected to the middle portion of the supporter 100 can be simply adjusted according to the positions of the frames 10 or the position of the sprinkler 20. That is, the supporter 100, the supporter clamps 200, and the sprinkler clamp 30 are integrated into the set type fire-fighting sprinkler installing device.

The supporter 100 is formed in a rectangular or polygonal pipe shape such that the supporter 100 does not run idle although weight is biased to one side of the supporter 100 under the condition that the supporter 100 is connected with the other parts.

Each of the clamp supporters 200, as shown in FIGS. 2 and 3, includes an upper horizontal surface and right and left vertical surfaces bent from the horizontal surface, which are integrally formed in a nippers shape. A connection hole 210, into which the supporter 100 is inserted, is formed through the upper portion of each of the vertical surfaces, and a contact plate 220, which is bent to press and fix the frame 10, is formed at the lower end of each of the vertical surfaces. Here, the connection holes 210 are formed to adjust the interval between the clamp supporters 200 under the condition that the supporter 100 is inserted into the connection holes 210. Further, a first bolt 230, which penetrates the center of the horizontal surface and is tightened to fix the upper end of the supporter 100 inserted into the connection holes 210, is provided, and a second bolt 240, which penetrates the vertical surfaces above the contact plates 220 to press the frame 10 inserted between the contact plates 220, is provided. Thus, the horizontal interval between the supporter clamps 200 at both ends of the supporter 100 is adjusted and fixed by the first bolts 230, and the positions of the supporter clamps 200 on the frames 10 are adjusted and fixed by the second bolts 240. Here, the first and second bolts 230 and 240 are wing bolts, which a user can easily tighten and loosen.

Further, a support piece 250 to support the lower portion of the inserted supporter 100 is bent from the front end of the lower portion of each of the right and left connection holes 210, and an internal maintenance piece 260, which is cut from one of the right and left vertical surfaces and is bent to the other one of the right and left vertical surfaces, is formed between the right and left vertical surfaces. Here, the internal maintenance piece 260 maintains the interval between the support pieces 250 or the vertical surfaces, and thus prevents the vertical surfaces from being excessively bent when the second bolt 240 is connected to the vertical surfaces.

In accordance with one embodiment, as shown in FIGS. 4 and 5, the sprinkler clamp 300 has a case shape, in which right and left surfaces are opened such that the supporter 100 can be inserted into the opened right and left surfaces, and upper and lower surfaces are widely extended forward and backward. A connection hole 310, into which the sprinkler 20 is vertically inserted, is formed through the middle portion of each of the upper and lower surfaces of the sprinkler clamp 300. That is, the supporter 100 is closely inserted between the upper and lower surfaces of the sprinkler clamp 300 and is adhered to the rear surface of the sprinkler clamp 300, and the sprinkler 20 vertically passes through the sprinkler clamp 300 in front of the supporter 100. Further, a third bolt 320, which penetrates at least one surface of the front and rear surfaces of the sprinkler clamp 300 connecting the upper and lower surfaces of the sprinkler clamp 300 and is tightened to fix the supporter 100 and the sprinkler 20 under the condition that the supporter 100 and the sprinkler 20 contact each other, is provided. That is, the supporter 100 between the upper and lower surfaces of the sprinkler supporter 300 contacts the outer surface of the sprinkler 20 penetrating the upper and lower surfaces of the sprinkler supporter 300. Through the above structure of contacting the supporter 100 and the sprinkler 20 by tightening the third bolt 320, the supporter 100, the sprinkler 20, and the sprinkler clamp 300 are integrally fixed without movement. Here, the upper and lower surfaces of the sprinkler clamp 300 are cut such that portions of the upper and lower surfaces of the sprinkler clamp 300 at the right or left side of the connection holes 310 are opened. That is, the sprinkler clamp 300 is configured such that the sprinkler 20 can be horizontally pushed into the sprinkler clamp 300 as well as be vertically inserted into the sprinkler clamp 300.

In accordance with a further embodiment, as shown in FIGS. 6 to 8, the sprinkler clamp 300 includes front and rear vertical surfaces, which are bent such that the supporter 100 can be inserted therebetween, formed at the rear end of the sprinkler clamp 300. Here, upper and lower support pieces 330a and 330b, which are bent inwardly by punching to support the lower portion of the supporter 100 and fix the upper portion of the supporter 100, are formed on each of the front and rear vertical surfaces, and a fourth bolt 340, which penetrates the front and rear vertical surfaces and is tightened to fix the supporter 100 inserted between the upper and lower support pieces 330a and 330b, is provided below the lower support pieces 330b. That is, the fourth bolt 340 is tightened under the condition that the supporter 100 is simply connected between the front and rear vertical surfaces, thereby allowing the supporter 100 to be firmly fixed to the sprinkler clamp 300 without movement through the upper and lower support pieces 330a and 330b.

In accordance with another embodiment, as shown in FIGS. 9 and 10, the sprinkler clamp 300 is configured such that the front portions of the connection holes 310 are opened under the condition that the front surface of the sprinkler clamp 300 is cut, a door 350 pivotally connected to one side of the connection holes 310 to be opened and closed under the condition that the door 350 covers the cut front surface and the upper and lower surfaces of the sprinkler clamp 300 partially including the front portions of the connection holes 310, a bracket 360 inserted between the upper and lower surfaces of the sprinkler clamp 300, provided with a coupling hole 362 formed through the front surface thereof to couple with the third bolt 320, and pivotally connected to the other side of the connection holes 310 to be rotated horizontally is provided, and an opened long hole 352 is formed at the tip of the door 350 contacting the bracket 360 at the same height as that of the coupling hole 362 such that the third bolt 320 can be pushed and inserted into the long hole 352. That is, based on the above constitution, the sprinkler 20 is pushed into the connection holes 310 under the condition that the third bolt 320 is loosened and the door 350 is opened, and then the third bolt 320 is tightened onto the bracket 360 under the condition that the door 350 is closed. Here, although the third bolt 320 is not completely separated from the bracket 360, the third bolt 320 can be inserted into the long hole 352 of the door 350 through the horizontal rotation of the door 350.

In accordance with yet another embodiment, as shown in FIGS. 11 and 12, the sprinkler clamp 300 has a case shape, in which right and left surfaces are opened such that the supporter 100 can be inserted into the opened right and left surfaces, and upper and lower surfaces are widely extended forward and backward. A connection hole 310, into which the sprinkler 20 is vertically inserted, is formed through the middle portion of each of the upper and lower surfaces of the sprinkler clamp 300. Further, an operation groove 370 is formed through a rear portion of the sprinkler clamp 310, to which the supporter 100 is connected, at a position where the rear surface and the upper surface contact, shaft pieces 380 bent forward are respectively formed at right and left sides of the rear surface of the sprinkler clamp 310, and an elastic clip 390, which penetrates the shaft pieces 380, includes a middle portion, which is protruded through the operation groove 370 under the condition that both ends of the elastic clip 390 are connected to the shaft pieces 380, and pushes the supporter 100 through the vertical rotation of the elastic clip 390 to fix the supporter 100 in a contact state with the sprinkler 20, is formed. That is, a unit to cause contact between the supporter 100 and the sprinkler 20 does not employ a bolt, but employs the elastic clip 390, i.e., a one-touch structure.

### INDUSTRIAL APPLICABILITY

As apparent from the above description, in the set type fire-fighting sprinkler installing device of the present invention, since the supporter 100, the supporter clamps 200 connected to both ends of the supporter 100, and the sprinkler clamp 300 connected to the middle of the supporter 100 are integrated into one set, the sprinkler 20 is easily variably installed according to the interval between the frames 10 installed on a ceiling and the position of the sprinkler 20 as well as is more simply and conveniently installed using the device, thus highly enhancing convenience in sprinkler installation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A set type fire-fighting sprinkler installing device, which installs a fire-fighting sprinkler through frames connectively installed on a ceiling lengthwise and crosswise, comprising:
a supporter having a designated length to traverse the frames installed at right and left sides thereof;
supporter clamps respectively connected to both ends of the supporter to adjust the interval therebetween and fixed to the upper ends of the frames; and
a sprinkler clamp connected to the middle portion of the supporter to connect a sprinkler in front thereof while fixing the supporter under the condition that the right and left end positions of the supporter are adjusted.

2. The set type fire-fighting sprinkler installing device according to claim 1, wherein each of the supporter clamps includes:
an upper horizontal surface and right and left vertical surfaces bent from the horizontal surface;
connection holes, into which the supporter is inserted, respectively formed through the upper portions of the right and left vertical surfaces;
contact plates, which are bent to press and fix the frames, respectively formed at the lower ends of the right and left vertical surfaces;
a first bolt penetrating the center of the horizontal surface and tightened to fix the upper end of the supporter inserted into the connection holes; and
a second bolt penetrating the right and left vertical surfaces above the contact plates to press the frame inserted between the contact plates.

3. The set type fire-fighting sprinkler installing device according to claim 2, wherein:
support pieces to support the lower portion of the inserted supporter are respectively bent from the front ends of the lower portions of the right and left connection holes; and
an internal maintenance piece, which is cut from one of the right and left vertical surfaces and is bent to the other one of the right and left vertical surfaces, is formed between the right and left vertical surfaces.

4. The set type fire-fighting sprinkler installing device according to claim 1, wherein the sprinkler clamp has a case shape, in which right and left surfaces are opened such that the supporter can be inserted into the opened right and left surfaces, and upper and lower surfaces are widely extended forward and backward; and
the sprinkler clamp includes:
connection holes, into which the sprinkler is vertically inserted, formed through the middle portions of the upper and lower surfaces; and
a third bolt penetrating at least one surface of the front and rear surfaces of the sprinkler clamp connecting the upper and lower surfaces and tightened to fix the supporter and the sprinkler under the condition that the supporter and the sprinkler contact each other.

5. The set type fire-fighting sprinkler installing device according to claim 4, wherein the upper and lower surfaces of the sprinkler clamp are cut such that portions of the upper and lower surfaces of the sprinkler clamp at the right or left side of the connection holes are opened.

6. The set type fire-fighting sprinkler installing device according to claim 4, wherein the sprinkler clamp includes:
front and rear vertical surfaces bent at the rear end of the sprinkler clamp such that the supporter can be inserted therebetween;
upper and lower support pieces bent inwardly by punching to support the lower portion of the supporter and fix the upper portion of the supporter; and
a fourth bolt penetrating the front and rear vertical surfaces below the lower support pieces and tightened to fix the supporter inserted between the upper and lower support pieces.

7. The set type fire-fighting sprinkler installing device according to claim 4, wherein the sprinkler clamp is configured such that the front portions of the connection holes are opened under the condition that the front surface of the sprinkler clamp is cut; and
the sprinkler clamp includes:
a door pivotally connected to one side of the connection holes to be opened and closed under the condition that the door covers the cut front surface and the upper and lower surfaces of the sprinkler clamp partially including the front portions of the connection holes;
a bracket inserted between the upper and lower surfaces of the sprinkler clamp, provided with a coupling hole formed through the front surface thereof to couple with the third bolt, and pivotally connected to the other side of the connection holes to be rotated horizontally; and
an opened long hole formed at the tip of the door contacting the bracket at the same height as that of the coupling hole such that the third bolt can be pushed into the long hole.

8. The set type fire-fighting sprinkler installing device according to claim 1, wherein the sprinkler clamp has a case shape, in which right and left surfaces are opened such that the supporter can be inserted into the opened right and left surfaces, and upper and lower surfaces are widely extended forward and backward; and
the sprinkler clamp includes:
connection holes, into which the sprinkler is vertically inserted, respectively formed through the middle portions of the upper and lower surfaces of the sprinkler clamp;
an operation groove formed through a rear portion of the sprinkler clamp, to which the supporter is connected, at a position where the rear surface and the upper surface contact;
shaft pieces respectively bent forward at right and left sides of the rear surface of the sprinkler clamp; and
an elastic clip penetrating the shaft pieces, including a middle portion, which is protruded through the operation groove under the condition that both ends of the elastic clip are connected to the shaft pieces, and pushing the supporter through the vertical rotation of the elastic clip to fix the supporter in a contact state with the sprinkler

9. The set type fire-fighting sprinkler installing device according to claim 5, wherein the sprinkler clamp includes:
front and rear vertical surfaces bent at the rear end of the sprinkler clamp such that the supporter can be inserted therebetween;
upper and lower support pieces bent inwardly by punching to support the lower portion of the supporter and fix the upper portion of the supporter; and
a fourth bolt penetrating the front and rear vertical surfaces below the lower support pieces and tightened to fix the supporter inserted between the upper and lower support pieces.
